(19) United States
(12) Patent Application Publication
(10) Pub. No.: US 2003/0016113 A1
(43) Pub. Date: Jan. 23, 2003

(54) Inductive component made with rectangular development planar windings

(76) Inventor: Davide Brocchi, Prato (IT)

Correspondence Address: Mark J. Patterson, Suite 2020, NationsBank Plaza, 414 Union Street, Nashville, TN, 37219, US

(21) Appl. No.: 10/176,395

(22) Filed: Jun. 20, 2002

(30) Foreign Application Priority Data
Jun. 21, 2001 (EP) 01830420.4

(51) Int. Cl. H01F 5/00

(52) U.S. Cl. 336/200

(57) ABSTRACT

The winding described is formed by a continuous laminar conductor (401), which, when disposed in a plane, presents a generally serpentine pattern consisting of a plurality of loops, and which is bent along lines bending (C1-C8) in such a way that the loops overlap one another, thus forming the turns of the winding. The loops are formed by rectilinear portions of the laminar conductor, and the winding in this way assumes a substantially rectangular shape.

This application claims benefit under 35 U.S.C. 119 (a) of co-pending European Application Serial No. 01830420.4 filed Jun. 21, 2001, in the European Patent Office, entitled “Rectangular-development planar windings and inductive component made with one or more of said windings” which is hereby incorporated by reference.

Be it known that I, Davide Brocchi, an Italian citizen residing in Prato, Italy have invented a new and useful “Inductive Component made with Rectangular Development Planar Windings”.

### FIELD OF THE INVENTION

The present invention relates to a planar winding, i.e., a winding made with a laminar metal conductor.

### DESCRIPTION OF THE PRIOR ART

Windings of the above type are commonly used in the electronics sector for making inductance coils or other inductive components, for instance transformers, and replace traditional windings made with circular section metal wires. The aforesaid windings and the corresponding components made therewith present a series of advantages, such as the small size and an improved heat exchange, which facilitates the dissipation of the heat generated by the Joule effect within the component.

From U.S. Pat. No. 4,959,630 and U.S. Pat. No. 5,017,902, planar transformers are known which use windings of this type and which comprise a primary winding with turns formed by a continuous laminar conductor that presents, when disposed in a plane (i.e., prior to bending to form the winding), a serpentine pattern. The secondary winding is made up of a series of lengths of laminar conductor, each of which forms a pair of turns of the secondary winding. These transformers are complex to assemble and are cumbersome. The turns of the primary and secondary windings are interspaced or interleaved, and their shape is such that, when bent, the overall dimensions of the turns are relatively extensive and irregular.

From U.S. Pat. No. 5,010,314 a planar transformer is known which is made up of a primary winding and a secondary winding, which are both formed by turns made of sheets of conductive material. The various turns are made starting from separate sheets, and thus must subsequently be soldered together or, in any case, connected electrically to obtain continuous windings. The manufacture of these transformers is complex and costly.

### SUMMARY OF THE INVENTION

The object of the present invention is to provide a planar winding, i.e., one made from a laminar conductor, which is easy to produce and which has small overall dimensions and is regular in order to facilitate its insertion into an inductive component, such as a transformer. A further object of the present invention is to provide a planar winding that can be produced with punching techniques from a sheet of conductive material, using simple and inexpensive tools.

The above and further purposes and advantages, which will appear clearly to persons skilled in the field from the ensuing text, are basically obtained with a winding formed by a continuous laminar conductor which, when disposed on a plane, presents a generally serpentine pattern consisting of a plurality of loops and which is bent along lines of bending in such a way as to bring said loops to overlap one another to form the turns of said winding, characterized in that the loops are formed by rectilinear portions of the laminar conductor.

According to a preferred practical embodiment of the invention, the contiguous rectilinear portions of the laminar conductor that form each loop are mutually orthogonal, and the loops preferably have a C-shaped or U shaped or rectangular development formed by three or four contiguous portions of laminar conductor. In this way, a winding with rectangular turns is obtained. The rectilinear portions of the laminar conductor preferably have a constant width.

In order to obtain the winding, the laminar conductor is advantageously and preferably bent along lines of bending at the intersections between contiguous rectilinear portions forming said loops.

According to a possible embodiment of the invention, at least one of the loops formed by the laminar conductor developed in a plane before bending has a size different from the remaining loops and has no bending lines inside it, since it is defined by a U-shaped or C-shaped segment of laminar conductor, whilst the remaining part is divided into L-shaped segments. In this way, in the bent conformation, the bending lines are staggered with respect to one another along the development of the turns of said winding.

Further advantageous embodiments of possible windings according to the invention are specified in the attached claims.

The invention also relates to an inductive component, such as an inductance coil or a transformer, comprising one or more windings obtained as specified above.

The invention will be better understood from the ensuing description and the attached drawings illustrating practical, non-limiting, embodiments of the invention.

### BRIEF DESCRIPTION OF THE DRAWINGS

FIG. 1 shows a plane development of the laminar conductor that forms the primary winding in a second embodiment.

FIG. 2 shows a plane development of the laminar conductor that forms the secondary winding in said second embodiment.

FIG. 3 is a perspective view of the laminar conductor of FIG. 1 in the bent condition.

FIG. 4 is a partial perspective view of the laminar conductor of FIG. 1. in the bending step with the indication of the sheets of insulating material to be interposed between the turns.

FIG. 5 is a perspective view of the laminar conductor of FIG. 2. in the bending step.

FIG. 6 is a partially exploded cross section of a transformer obtained by means of the two windings constituted by the laminar conductors of FIGS. 1 and 2 in the bent condition.

FIG. 7 is a view according to the line VII-VII of FIG. 6.

FIG. 8 is a different embodiment of the laminar conductor in the plane configuration.

FIG. 9 is a further embodiment of the laminar conductor in the plane configuration.

FIG. 10 is a laminar conductor configured in the same way as the conductor of FIG. 9, but with a smaller number of loops, and hence designed to form a winding with a smaller number of turns.

### DESCRIPTION OF THE PREFERRED EMBODIMENTS

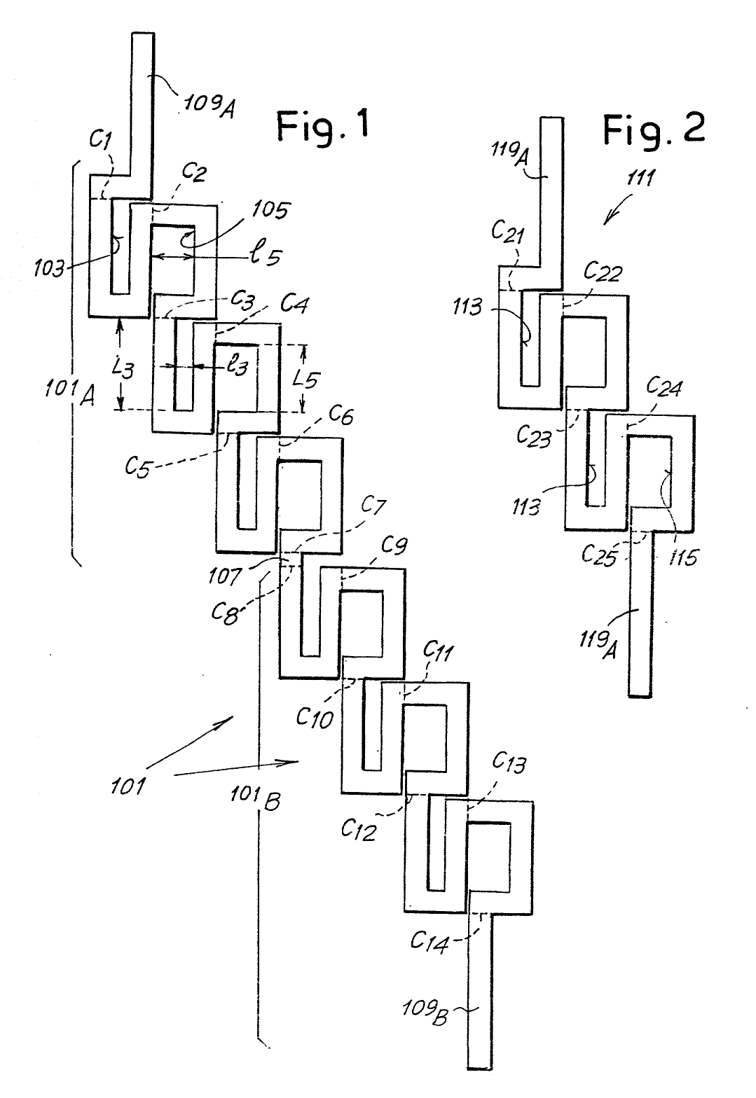

FIGS. 1 to 5 show an embodiment of two windings for making a planar transformer, the windings being particularly designed to be obtained by means of punching. It is to be understood that the windings according to the invention can be employed also for different uses, for example, for making inductance coils or other electronic components which require the use of one or more windings.

FIG. 1 shows the plane development of a first continuous laminar conductor, designated as a whole by 101, which is designed to form a first winding of the transformer, hereinafter conventionally referred to as primary winding of the transformer. The laminar conductor 101 is shaped according to a generically serpentine pattern consisting of a succession of loops, which, in the figure, are designated by 103 and 105. The loops 103, 105 are divided into two series which constitute two portions 101A and 101B of the laminar conductor and which form, once the laminar conductor is bent, two sets of loops. The two sets of loops are joined together by an intermediate portion 107 of laminar conductor.

The reference numbers 109A and 109B designate the end portions of the laminar conductor which form the connections of the winding.

As may be seen in FIG. 1, all the loops 103 and 105 present a rectangular development and are made up of four contiguous rectilinear portions of the laminar conductor. All the rectilinear portions of the continuous laminar conductor 1 (including the intermediate portion 107) have the same width. Each loop has, at its center, an empty rectangular space. The rectangular loops 103 have a width smaller than that of the rectangular loops 105. Consequently, the empty rectangular spaces at the centers of the loops 103 have a smaller width than the empty rectangular spaces inside the loops 105. In greater detail, the width, 115 designated by 15, of each empty rectangular space inside the loops 105 is equal to the width 13 of the loops 103 increased by the width of the laminar conductor, i.e., the width of the rectilinear portions defining each loop.

Likewise, the empty space inside the “narrow” loops 103 has a length different from the length of the “wide” loops 105. In greater detail, the length L3 of the empty rectangular spaces inside the loops 103 is equal to the length L5 of the empty rectangular spaces inside the loops 105 increased by the aforesaid width of the rectilinear portions of conductor defining each loop.

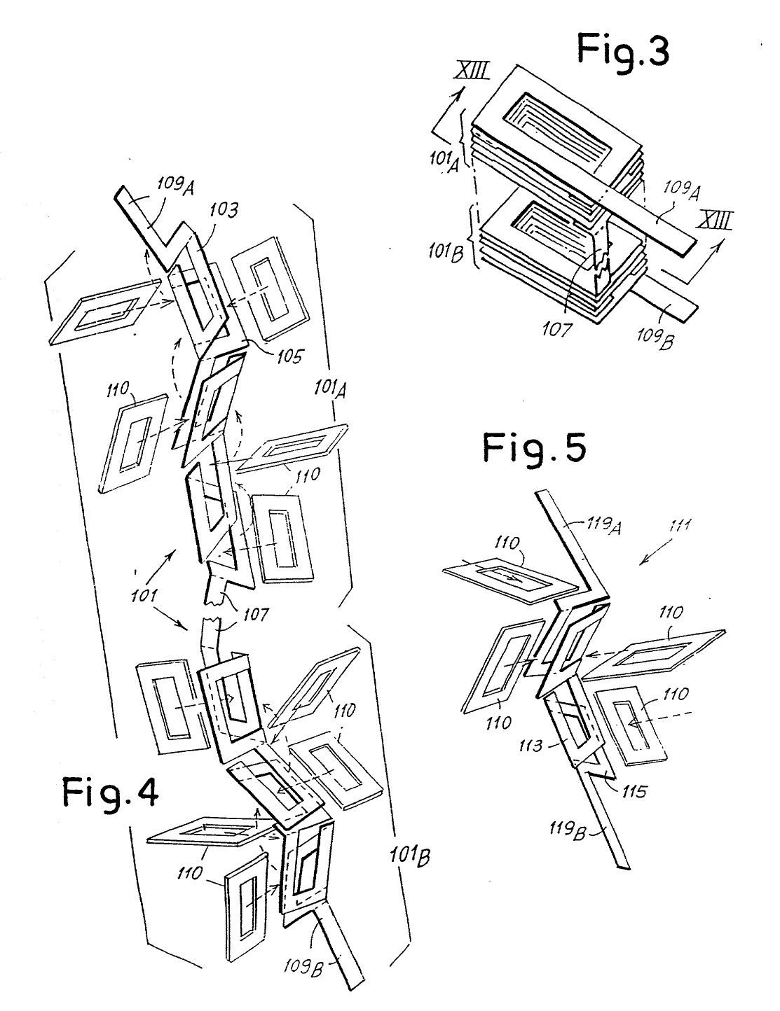

C1-C14, designate the bending lines along which the continuous laminar conductor is bent. The end portion 109A is tilted over against the first loop 103 by bending it along the line C1. Bending is obtained, for example, by bringing the end portion 109A outside the plane of the figure downwards. Subsequently, the ensemble formed by the first turn 103 and the end portion 109A is tilted over against the loop turn 105 by folding against the line C2, and so forth. The result may be seen in FIG. 3, whilst FIG. 4 is a schematic perspective representation with the laminar conductor partially bent. The loops 103 and 105 of the set forming the portion 101 A of the laminar conductor 101 thus form a first set of turns, again designated by 101 A, which is joined, by means of the intermediate portion 107, to a second set of turns formed by the loops 103 and 105 of the second portion 101 B of the laminar conductor.

A sheet of insulating material, designated as a whole by 110 and schematically illustrated in FIG. 4 is inserted between successive loops. Alternatively, the laminar conductor 101 can be varnished with an insulating vanish or can be applied on a film of insulating material.

Between the two sets of turns 101A and 101B there is inserted the secondary winding which is formed by bending a second continuous laminar conductor 111, the plane development of which is shown in FIG. 2. The loops formed by the second continuous laminar conductor 111 are designated by 113 and 115. These loops have the same shape and size as the rectangular loops 103 and 105, and will not therefore be described in detail. The reference numbers 119A and 119B designate the end portions designed to form the connections of the secondary winding C21-C25 designate the lines of bending. FIG. 5 is a perspective view of the continuous laminar conductor 111 in the bending step, with a schematic illustration of the insertion of the sheets of insulating material between adjacent turns.

By the bending as described above of the laminar conductors 101 and 111, packs or sets of turns are obtained with a central empty space with rectangular development having a width equal to the dimension 13 and a length equal to the dimension L5. The turn develops according to a rectangular pattern about a central axis common to the primary winding and secondary winding.

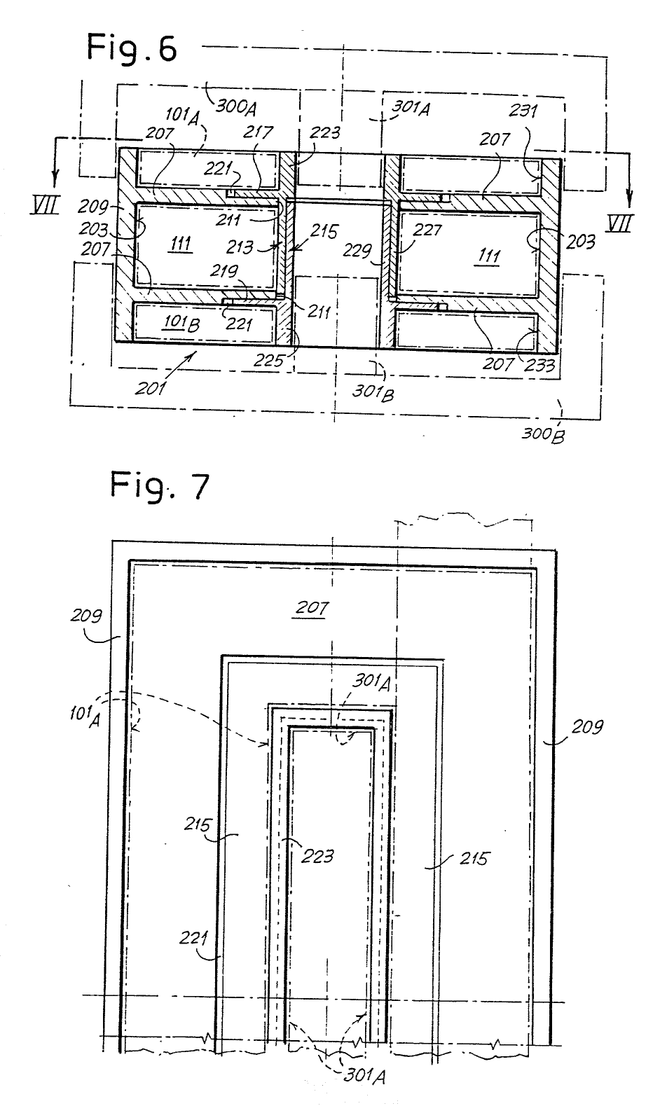

The central dimension of the empty space of the windings corresponds to the dimension, in cross section, of the central portion of the ferrite core, which is made up of two equal portions as shown in FIG. 6 to which reference will be made in greater detail later. The dimensions, in cross section, of the central portion of the ferrite core are in actual fact slightly smaller than the dimensions of the empty rectangular spaces inside the turns in order to enable the sheets of insulating material set between the turns to project slightly and provide lateral insulation.

The conformation of the loops illustrated in FIGS. 1 and 2 is such that they can be easily obtained using simple punching tools. In addition, the arrangement of the lines of bending is such that, in the final winding, the lines of bending are staggered with respect to one another along the development of the turns, with a consequent decrease in the overall height of the transformer.

FIGS. 6 and 7 respectively show an axial cross section and a section orthogonal to the axis of a transformer obtained with the windings of the previous figures. The windings 101 (in the two portions 101 A and 101 B) and 111 are illustrated very schematically and are housed in seats defined by an insulating container, designated as a whole by 201. Said container 201 has an internal compartment 203, inside which the winding 111 is set, said compartment 203 being defined by two parallel plane walls 207 and an external perimeter wall 209. The two parallel plane walls 207 each have an opening 211 through which there extend the central parts 301A and 301B respectively of the two portions 300A and 300B forming the ferromagnetic core of the transformer. The central part 301 A and 301 B of the ferromagnetic core is surrounded by two coaxial insulating sleeves 213 and 215 which insert into the openings 211 of the plane walls 207 of the container 201. The two insulating sleeves 213 and 215 each have a flange 217 and 219, which inserts into a lowered seat made in the external surface of the two plane walls 207 of the container 201. From each flange 217 and 219 there extends a tubular wall 223 and 225, respectively, with rectangular cross section, which develops towards the outside of the container 201. On the opposite side of each flange 217 and 219 there develops a further respective tubular wall with rectangular cross section, designated by 229 and 227, respectively. The two walls 227 and 229 are sized in such a way that they can be inserted into one another, the wall 229 being of smaller cross-sectional dimensions.

On the outside of the walls 207 two seats 231 and 233 are thus defined which are parametrically delimited externally by the wall 209 and internally respectively by the wall 223 and by the wall 225. -in the two seats 231 and 233 there are housed the two portions 101 A and 101 B of the winding 101.

In this way, the two windings are adequately insulated from one another and from the ferromagnetic core. Also, a sheet of insulating material can be set between the first turn of the primary winding 101 and the ferromagnetic core, and another sheet of insulating material can be set between the last turn of the primary winding 101 and the ferromagnetic core.

The conformation of the first winding, with the portion 107 of joining of the two series of turns formed by the conductor illustrated in FIG. 1, can be made also with different shapes of the loops, and hence of the turns of the laminar conductor, for example with turns having a circular development.

Also in the latter case, there is the advantage of obtaining a transformer with a first winding made of a continuous conductor but divided into two portions between which is inserted a second winding.

In general, then, and regardless of the shape of the turns, it is possible to envisage a transformer comprising at least and first winding and at least one second winding, in which at least said first winding is formed by a first continuous laminar conductor which, when disposed in a plane, presents a generally serpentine pattern consisting of a plurality of loops and which is bent to bring said loops to overlap one another to form the turns of said first winding about an axis, characterized in that said turns of the first winding are divided into at least a first set and a second set of turns, made up, respectively, of a first series of said loops and of a second series of said loops, the two sets of turns being at a distance apart from one another and being connected by an intermediate portion of said first laminar conductor, said at least one second winding being inserted between said first set of turns and said second set of turns.

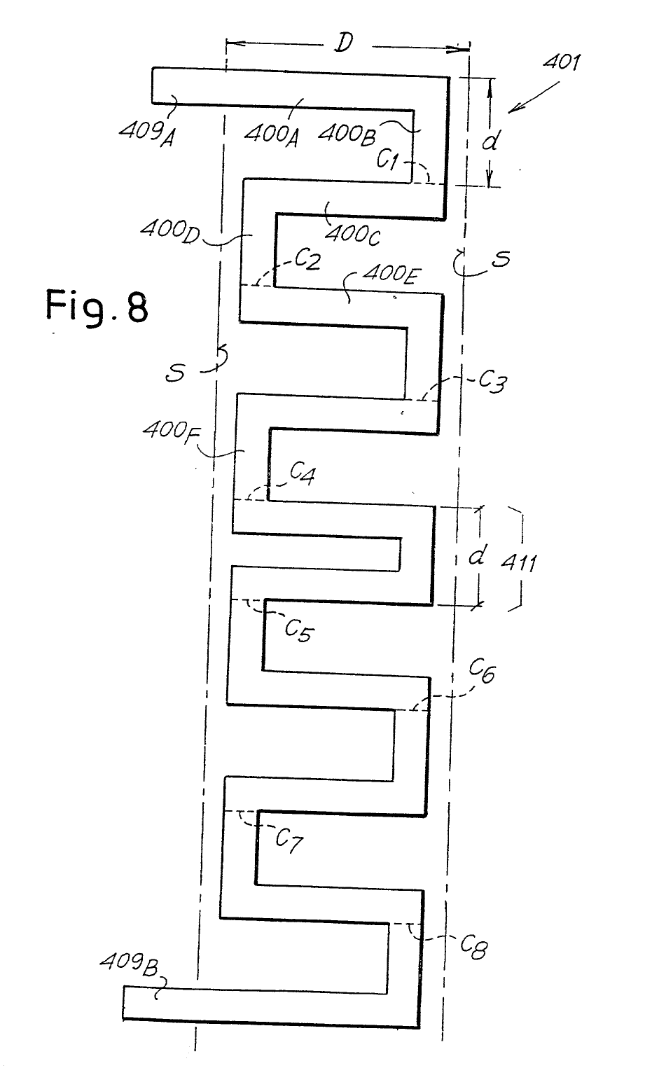

FIG. 8 shows, in a plane development similar to that of FIG. 1, a different embodiment of the laminar conductor for making a winding according to the invention. In this case, the continuous laminar conductor, generically designated by 401, forms a plurality of square loops, each consisting of rectilinear portions of the laminar conductor itself, designated by 400A, 400B, 400C, 400D, 400E for the first two loops starting from the top of FIG. 8. The individual rectilinear portions of conductor have the same width. The reference numbers 409A and 409B designate the ends of the laminar conductor that are to form the connections of the winding.

C1, C2, C3 . . . C8 designate lines of bending parallel to a direction orthogonal to the overall development of the laminar conductor, which extends along a rectangular strip, indicated by a dashed line and by the letter S. The lines of bending C1-C8. divide the laminar conductor 401 into a series of L-shaped segments, with the long branch of the L orthogonal to the development of the strip S along which the laminar conductor 401 extends. At the center, between the two lines of bending C4 and C5, there is a loop, designated by 411, of a smaller size than the adjacent loops for the purposes which will be described hereinafter, which constitutes a U-shaped segment of conductor.

It may be readily understood from FIG. 8 that when the laminar conductor 401 is bent along the lines of bending C1-C8 to form the winding (which will have a rectangular development in plan view with dimensions equal to the dimensions D and d of the longer branch and shorter branch, respectively, of each L-shaped segment into which the lines of bending C1-C8 divide the laminar conductor 401), the-lines of bending will be staggered with respect to one another and set at the four vertices of a rectangle, this being due precisely to the presence, in an intermediate position, of the U-shaped loop 411. A distribution of the lines of bending in the final winding is thus obtained, with a consequent reduction in the axial dimension of the winding itself and a greater uniformity in the distribution of the thicknesses, as in the case of the embodiment illustrated in FIGS. 1 and 2.

In order to obtain a winding divided into two sets of turns as in the previous case, it is sufficient, for example, for the rectilinear portion 400F of conductor to be longer than the equivalent portions and to have two lines of bending, namely the line C4 and a further line parallel to it, the distance between the two lines of bending corresponding to the difference in length between this portion of conductor and the corresponding portions (e.g., the portions 400B and 400D) of the other loops.

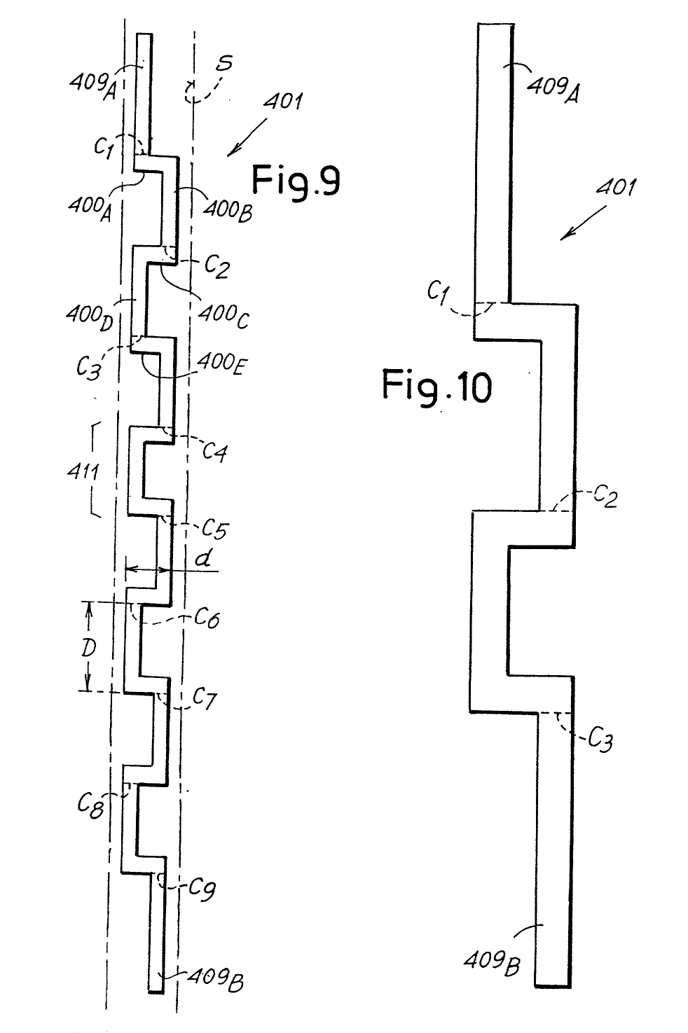

FIG. 9 shows a variant embodiment of the laminar conductor of FIG. 8. The same reference numbers designate parts that are the same, or that correspond. Unlike the case illustrated in FIG. 8, in FIG. 9 the L-shaped segments into which the lines of bending C1-C9 divide the laminar conductor are arranged with their own long branches parallel to the development of the strip S along which the laminar conductor extends. The loops are thus C-shaped instead of U-shaped as in the previous case. Also in the present case there exists an intermediate segment, delimited between the two lines of bending C4 and C6,which is C-shaped instead of L-shaped, for the same purposes as those explained previously, i.e., for obtaining a better distribution of the lines of bending in the final winding. It is moreover possible, as in the previous case, to envisage that one of the rectilinear portions defining the long of the L-shaped segments into which the conductor is divided has a length greater than the others and has a pair of lines of bending to obtain a winding divided into two parts. In this case, since an even number of loops is envisaged in the laminar conductor, the C-shaped segment 411 is not set in an exactly central position in the development of the conductor.

FIG. 10 shows a laminar conductor similar to that of FIG. 9, but with a much more contained development. Again, the same reference numbers designate parts that are the same or that correspond. The conductors of FIGS. 9 and 10 can be used, for example (when they are bent along the respective lines of bending C), as a primary winding and a secondary winding of a transformer.

As compared to the first example of embodiment, where the laminar conductor develops diagonally, the embodiments illustrated in FIGS. 8 to 10 enable better exploitation of the base material from which the winding is made, for example by punching.

It is understood that the drawings only illustrate, by way of example, practical embodiments of the invention, which may vary in its embodiments and arrangements without thereby departing from the scope of the underlying idea.

What is claimed is:

1. A winding formed by a continuous laminar conductor which, when disposed in a plane, presents a generally serpentine pattern consisting of a plurality of loops and which is bent along lines of bending to bring said loops to overlap one another to form the turns of said winding,
characterized in that said loops are formed by rectilinear portions of the laminar conductor.

2. The winding according to claim 1, characterized in that the contiguous rectilinear portions of the laminar conductor that form each loop are orthogonal to one another.

3. The winding according to claim 2, characterized in that said loops have a C-sha0ed or U-shaped or rectangular development made up of three or four contiguous portions of laminar conductor, the winding, when bent, having a rectangular development.

4. The winding according to claim 1, 2, or 3, characterized in that said rectilinear portions of the laminar conductor have a constant width.

5. The winding according to one or more of the foregoing claims, characterized in that said laminar conductor is bent along lines of bending at the intersection between contiguous rectilinear portions forming said loops.

6. The winding according to one or more of the foregoing claims, characterized in that at least one of said loops has a size different from that of the remaining loops in such a way that, in the bent configuration, the lines of bending are staggered with respect to one another along the development of the turns of said winding.

7. The winding according to one or more of the foregoing claims, characterized in that said laminar conductor forms loops having a greater width and loops having a smaller width, in said serpentine development loops of smaller width alternating with loops of greater width with a 1:1 ratio.

8. The winding according to claim 7, characterized in that each of said loops is defined by four rectilinear portions of constant width of said laminar conductor, between which an empty rectangular space is present which is delimited by two longer sides and two shorter sides.

9. The winding according to claim 8, characterized in that the smaller sides of the empty rectangular space of the loops of greater width are equal to the smaller sides of the empty space of the loops of smaller width increased by the width of said rectilinear portions of the laminar conductor.

10. The winding according to claim 9, characterized in that the longer sides of the empty rectangular space of the loops of smaller width are equal to the longer sides of the empty space of the loops of larger width increased by the width of said rectilinear portions of the laminar conductor.

11. The winding according to claim 8, 9, or 10, characterized in that one of the rectilinear portions of said laminar conductor, defining one of the loops of smaller width, has a length greater than that of the corresponding remaining rectilinear portions, the difference in length forming an intermediate portion between one first set of loops and one second set of loops.

12. The winding according to one or more. of claims 1 to 6, characterized in that said lines of bending divide the laminar conductor into a plurality of L-shaped segments, each formed by two contiguous rectilinear portions, when disposed in a plane said segments developing according to a rectilinear strip.

13. The winding according to claim 12, characterized in that said lines of bending delimit, in said laminar conductor, an intermediate U-shaped or C-shaped segment.

14. An inductance coil comprising a winding according to one or more of claims 1 to 13.

15. A transformer comprising at least a first winding and at least a second winding and a ferromagnetic core defining a magnetic circuit, characterized in that at least one of said first winding and said second winding consists of a winding according to one, or more of claims 1 to 13.

16. The transformer according to claim 15, characterized in that both of said first winding and said second winding consist of windings according to one or more of claims 1 to 13.

17. The transformer according to claim 15 or claim 16, characterized in that said turns of the first winding are divided into at least one first set and at least one second set of turns, respectively constituted by a first series of said loops and a second series of said loops, the two sets of turns being at a distance apart from one another and being connected by an intermediate portion of said laminar conductor, at least one second winding being inserted between said first set of turns and said second set of turns.
